(19) United States
(12) Patent Application Publication
(10) Pub. No.: US 2025/0184977 A1
(43) Pub. Date: Jun. 5, 2025

(54) MAXIMUM AGGREGATED BANDWIDTH REPORTING FOR CARRIER AGGREGATION

(71) Applicant: T-MOBILE INNOVATIONS LLC, Overland Park, KS (US)

(72) Inventor: William M. SHVODIAN, McLean, VA (US)

(21) Appl. No.: 18/945,090

(22) Filed: Nov. 12, 2024

Related U.S. Application Data
(60) Provisional application No. 63/597,692, filed on Nov. 9, 2023.

(51) Int. Cl. H04W 72/0453; H04W 28/06; H04W 72/0446

(52) U.S. Cl. CPC H04W 72/0453; H04W 28/065; H04W 72/0446

(57) ABSTRACT

Embodiments of the present disclosure are directed to systems and methods for reporting user equipment (UE) capabilities for carrier aggregation sessions. Instead of, or in addition to, reporting maximum bandwidth processing capabilities, the present disclosure utilizes an information element reported by the UE that includes the maximum number of resource blocks or subcarriers that can be processed by the baseband processor of the UE.

### CROSS-REFERENCE TO RELATED APPLICATIONS

This application claims the benefit of U.S. Provisional Patent Application No. 63/597,692, filed on Nov. 9, 2023, the entirety of which is incorporated herein by reference.

### SUMMARY

The present disclosure is directed to user equipment (UE) maximum aggregated bandwidth capabilities for use with carrier aggregation, substantially as shown and/or described in connection with at least one of the Figures, and as set forth more completely in the claims.

According to various aspects of the technology, a UE has a particular maximum capability to process signals in a wireless telecommunication session using carrier aggregation. Conventionally, a UE can report various combinations of component carriers as part of its capability messaging. As greater flexibility is introduced in the configuration of individual component carriers, it will become increasingly insufficient to only report the number of component carriers that a UE can (or would prefer to) use in carrier aggregation. Instead of, or in addition to, reporting maximum bandwidth processing capabilities for radio resource allocation, the present disclosure utilizes an information element reported by the UE that includes the maximum number of resource blocks or subcarriers that that can be processed by the baseband processor of the UE, allowing radio access networks greater flexibility in allocating radio resources while minimizing the signaling burden on a UE.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIG. 2 illustrates a diagram of an exemplary environment in which implementations of the present disclosure may be employed;

FIG. 3 illustrates a portion of an information element for reporting UE aggregated bandwidth capability, in accordance with embodiments of the present disclosure;

FIG. 4 depicts a flow diagram of an exemplary method for reporting aggregated bandwidth capability of a UE in a carrier aggregation session, in accordance with embodiments described herein;

FIG. 5 depicts a flow diagram of an exemplary method for carrier aggregation control by a radio access network, in accordance with embodiments of the present disclosure;

FIG. 6 illustrates a portion of an information element for reporting UE aggregated bandwidth capability, in accordance with embodiments of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “node” is used to refer to an access point that transmits signals to a UE and receives signals from the UE in order to allow the UE to connect to a broader data or cellular network (including by way of one or more intermediary networks, gateways, or the like)

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Accordingly, a first aspect of the present disclosure is directed to a system for reporting maximum supported bandwidth from a UE to a radio access network. The system comprises one or more antennas configured to wirelessly communicate with a base station of a radio access network. The system further comprises one or more computer processing components configured to perform operations that effectuate the reporting of maximum supported bandwidth of the UE. The operations comprise determining a maximum resource block baseband processing capability of the UE. The operations further comprise communicating an information element to the base station comprising the maximum resource block baseband processing capability of the UE. The operations further comprise receiving an instruction from the base station to configure a carrier aggregation session, the carrier aggregation comprising a plurality of component carriers, wherein the plurality of component carriers comprises an amount of resource blocks less than the maximum resource block baseband capability of the UE.

A second aspect of the present disclosure is directed to a method for establishing a carrier aggregation communication session for a UE. The method comprises transmitting a UE capability inquiry from a base station of a RAN to a UE that causes the UE to send a UE capability information message comprising one or more carrier aggregation parameters. The method further comprises receiving, from the UE, the UE capability information message, wherein the UE capability information message comprises the one or more carrier aggregation parameters, and wherein the one or more carrier aggregation parameters comprises a number of resource blocks associated with the UE's maximum aggregated bandwidth. The method further comprises allocating a plurality of component carriers to the UE for a carrier aggregation session, wherein a sum of a number of resource blocks for all of the plurality of component carriers is less than or equal to the number of resource blocks associated with the UE's maximum aggregated bandwidth.

Another aspect of the technology described herein is directed to a method for reporting carrier aggregation parameters from a UE to a RAN. The method comprises determining a maximum number of resource blocks supported by the UE for carrier aggregation. The method further comprises communicating a UE capability information message from the UE to the RAN, wherein the UE capability information message comprises one or more carrier aggregation parameters, the one or more carrier aggregation parameters comprising the maximum number of resource blocks supported by the UE for carrier aggregation. The method further comprises receiving one or more radio resource control (RRC) configuration messages that instructs the UE to establish a carrier aggregation session with a plurality of component carriers, wherein a sum of a number of resource blocks for all of the plurality of component carriers is less than or equal to the maximum number of resource blocks supported by the UE for carrier aggregation.

Yet another aspect of the present disclosure is directed to a non-transitory computer readable media containing instructions thereon that, when executed by a computer processing component, cause the computer processing component to perform a method for reporting maximum supported bandwidth of a UE for a carrier aggregation communication session. The method comprises determining a maximum number of resource blocks supported by the UE for carrier aggregation. The method further comprises communicating a UE capability information message from the UE to the RAN, wherein the UE capability information message comprises one or more carrier aggregation parameters, the one or more carrier aggregation parameters comprising the maximum number of resource blocks supported by the UE for carrier aggregation. The method further comprises receiving one or more radio resource control (RRC) configuration messages that instructs the UE to establish a carrier aggregation session with a plurality of component carriers, wherein a sum of a number of resource blocks for all of the plurality of component carriers is less than or equal to the maximum number of resource blocks supported by the UE for carrier aggregation.

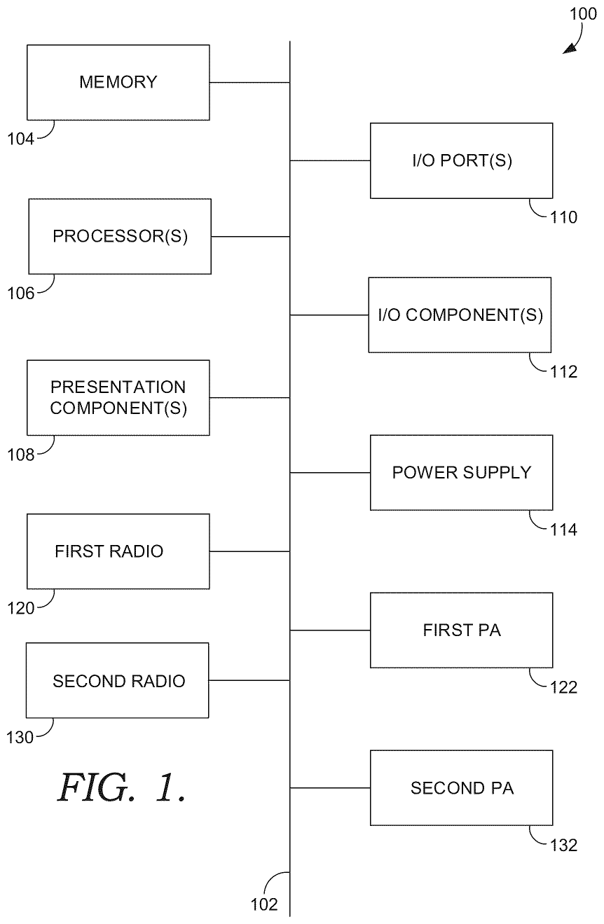

Referring to FIG. 1, a representative computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, extended reality (XR) devices (e.g., virtual reality, augmented reality, or mixed reality devices), computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

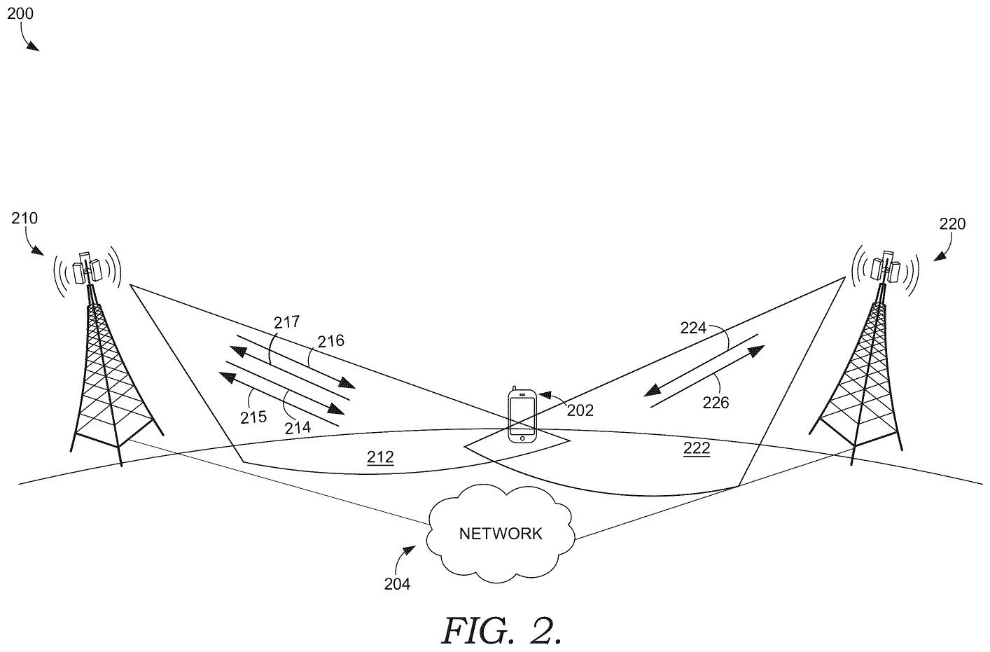

Turning now to FIG. 2, an exemplary network environment is illustrated in which implementations of the present disclosure may be employed. Such a network environment is illustrated and designated generally as network environment 200. At a high level the network environment 200 comprises a UE 202, a first base station 210, a second base station 220, and a network 204. It should be understood that more than one of each component is expressly conceived as being within the bounds of the present disclosure; for example, the network environment 200 may comprise additional base stations, additional UEs, and/or additional networks. Similarly, though certain objects of network environment 200 are illustrated in a certain form, it should be understood that they may take other forms; for example, even though the UE 202 is illustrated as a cellular phone, a UE suitable for implementations with the present disclosure may be any computing device having any one or more aspects described with respect to FIG. 1, and even though the first base station 210 and the second base station 220 are illustrated as macro cells mounted on towers, a base station suitable for use with the present disclosure may be terrestrial or extra-terrestrial (e.g., a satellite of a satellite radio access network) and may be of any scale desirable by a mobile network operator (MNO) (e.g., a small cell, pico cell, relay, and the like).

The network environment 200 includes one or more terrestrial base stations, represented by the first base station 210 and the second base station 220. Each of the first base station 210 and the second base station 220 are connected to the network (e.g., a MNO core network) and are configured to wirelessly communicate with one or more UEs, such as the UE 202. The first base station 210 is configured to transmit one or more component carriers in the downlink to a first coverage area 212 and to receive one or more component carriers in the uplink from a UE located within the first coverage area 212. As such, the first base station 210 may be configured to transmit a first downlink component carrier 214 and a second downlink component carrier 216, and to receive a first uplink component carrier 215 and a second uplink component carrier 217. In aspects, each of said component carriers may be characterized by their utilization of frequency domain duplexing (FDD) or time domain duplexing (TDD); for example, the first downlink component carrier 214 may be FDD and the second downlink component carrier 216 may be TDD (in another aspect, both may be FDD or both may be TDD). The second base station 220 may be similarly configured to transmit a third downlink component carrier 224 to a second coverage area 222 and receive a third uplink component carrier 226 from a UE located in the second coverage area 222. In aspects, each of the first downlink component carrier 214, the first uplink component carrier 215, the second downlink component carrier 216, and the second uplink component carrier 217 may be FDD signals, and each of the third downlink component carrier 224 and the third uplink component carrier 226 may be TDD signals. Though illustrated as having a single cell so as not to obfuscate the present disclosure, it should be understood that the first base station 210 may utilize a plurality of different cells to communicate signals to the UE 202; thus, in aspects, each of the first downlink component carrier 214 and the first uplink component carrier 215 are communicated between the UE 202 and a primary cell, each of the second downlink component carrier 216 and the second uplink component carrier 217 are communicated between the UE 202 and a first secondary cell, and each of the third downlink component carrier 224 and the third uplink component carrier 226 are communicated between the UE 202 and a second secondary cell.

The simultaneous (or near simultaneous) use of multiple component carriers is generally referred to as carrier aggregation, and may be utilized by the UE 202 in order, for example, to increase the amount of data that may be transmitted or received by the UE 202. The UE 202 comprises one or more components that, together, may be said to comprise a baseband processor, which handles tasks such as demodulation, decoding, error correction, and channel equalization. Relevant to the present disclosure, the UE 202 has a limit, based on the capabilities of its particular baseband processor, for how much bandwidth it can process. For example, a UE may have a total baseband processing limit of 20 MHz, 100 MHz, 160 MHz, or more (or less); further, a UE may additionally or alternatively have a baseband processing limit for each component carrier, depending on whether the component carrier is FDD and TDD signals (e.g., a limit of 50 MHz for FDD component carriers and a limit of 100 MHz for TDD component carriers).

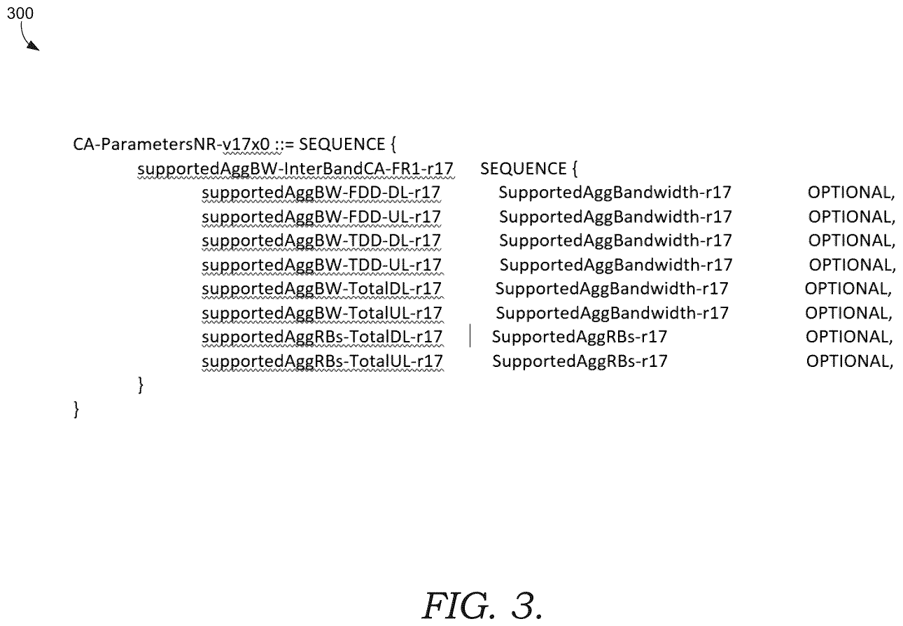

Carrier aggregation is the result of a series of interactions between the UE 202 and a base station (e.g., the first base station 210). Generally, the first base station 210 may transmit a UE capability inquiry message to the UE 202. The UE capability inquiry message consistent with the present disclosure will trigger the UE 202 to transmit a UE capability information message that comprises one or more carrier aggregation parameters. A portion of the UE capability information message is shown as message 300 in FIG. 3. The one or more carrier aggregation parameters comprises a maximum supported aggregate resource blocks. In aspects, the maximum supported aggregate resource blocks is a single value that represents a total of uplink and downlink capabilities; in another aspect, the maximum supported aggregate resource block comprises a first value for the maximum capabilities of a UE's capacity to process downlink bandwidth and a second value for the maximum capabilities of the UE's capacity to process uplink bandwidth. In other aspects, the one or more carrier aggregation parameters may comprise one or more of a maximum supported aggregate FDD downlink bandwidth, a maximum supported FDD uplink bandwidth, a maximum supported TDD downlink bandwidth, a maximum supported TDD uplink bandwidth, a maximum total downlink bandwidth, and a maximum total uplink bandwidth. In some aspects, the maximum supported aggregate resource blocks is reported as a UE capability instead of reporting its supported feature set(s). A feature set is a specific combination of information that is used by the base station 210 to make radio resource decisions, and comprises one or more of supported frequency bands, maximum bandwidth, MIMO configurations, subcarrier spacings (SCS), and the number of aggregated component carriers (CCs) the UE 202 can support. In some aspects, the maximum supported aggregate resource blocks is reported by the UE 202 in addition to is supported feature set(s).

The maximum supported aggregate resource block value (or values) is agnostic to numerology. Because the UE reports the UE's maximum capacity for processing baseband data, the first base station 210 may allocate a wider variety of carrier aggregation combinations; for example, if the UE 202 reports a maximum supported aggregate resource block downlink value of 820 resource blocks, the UE 202 may be allocated three 100 MHz component carriers of TDD with a subcarrier spacing of 30 kHz (3 component carriers*273 resource blocks per 100 MHz bandwidth at 30 kHz subcarrier spacing), three 50 MHz component carriers of FDD with a subcarrier spacing of 15 kHz (3 component carrier*270 resource blocks per 50 MHz bandwidth using 15 kHz subcarrier spacing) or any combination of FDD and TDD component carriers wherein the total number of resource blocks for all of the allocated component carriers is less than or equal to the UE's maximum supported aggregate resource block value.

In some aspects of the present disclosure, the UE 202 may report its aggregated bandwidth capabilities using a scaling factor. In many implementations, the first base station 210 may utilize a 15 kHz subcarrier spacing for FDD and a 30 kHz subcarrier spacing for TDD. Because of the different subcarrier spacing, many different combinations of FDD and TDD radio resources can be allocated to the UE. In addition to, or instead of reporting a large number of supported feature sets, the UE 202 may report in its UE capability messaging, that it supports the use of a scaling factor and a maximum total aggregated bandwidth. The scaling factor may be used to equate different subcarrier spacing to more accurately reflect the UE 202's capabilities. Because there are essentially twice as many subcarriers per MHz using 15 kHz subcarrier spacing as per MHz using 30 kHz subcarrier spacing, a scaling factor of 2 could be used for FDD resources having a 15 kHz subcarrier spacing and a scaling factor of 1 could be used for TDD resources having a 30 kHz subcarrier spacing. Other scaling factors could be use, relative to the scaling factor of 1; for example, a 60 kHz subcarrier spacing could have a scaling factor of 0.5, and a 120 kHz subcarrier spacing could have a scaling factor of 0.25. In other aspects, if the scaling factor was determined with respect to a different base line, different scaling values could be used (e.g., if 60 kHz subcarrier spacing had a scaling factor of 1, then 30 kHz would have a scaling factor of 2 and 15 kHz would have a scaling factor of 4).

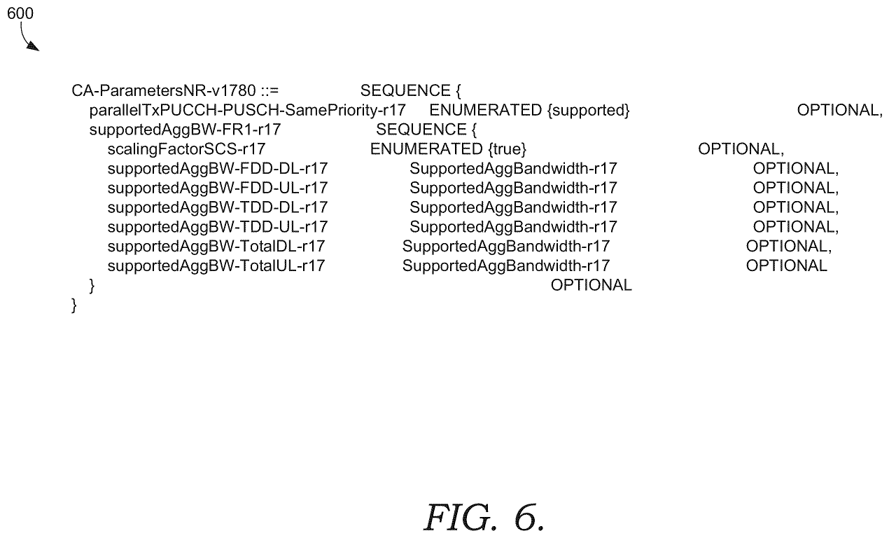

In combination with the scaling factor, the UE 202 will report its maximum supported aggregated bandwidth, for use by the first base station 210 in radio resource allocation. In a first example, the UE 202 signals support for a scaling factor, and it reports that a maximum number of resource blocks that represent a maximum supported aggregated bandwidth. In such an example, the maximum supported aggregated resource blocks may be reported as a total downlink value, with or without individual total FDD and TDD values. In another example, the UE 202 signals support for a scaling factor and reports a maximum supported aggregated bandwidth in MHz. Such an example is shown in FIG. 6 as a portion of the UE capability information message 600. In the example illustrated by FIG. 6, the UE 202 of FIG. 2 reports that it supports a scaling factor, and (among other information elements) a supported aggregated FDD downlink value, a supported aggregated TDD downlink value, and a total aggregated downlink value. If the UE capability information message 600 indicated the scaling factor is enumerated, a maximum supported FDD bandwidth is 100 MHz, a maximum supported TDD bandwidth is 200 MHz, and a total supported aggregated downlink bandwidth is 200 MHZ, then any combination of “F” and “T” could be assigned to the UE such that (2F)+(1T)≤200, wherein “F” is the FDD portion of the downlink radio resource allocation and “T” is the TDD portion of the downlink radio resource allocation.

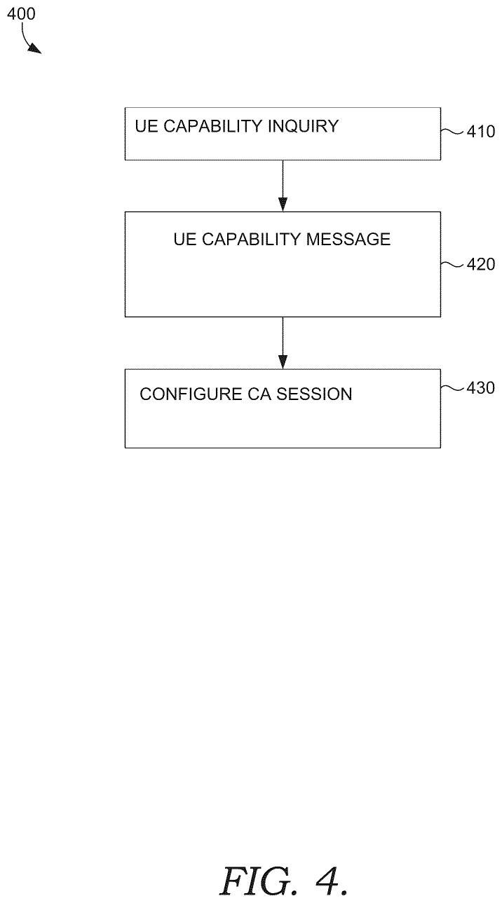

Turning now to FIG. 4, a flow chart representing a method 400 is provided for establishing a carrier aggregation communication session for a UE. At a first step 410, a UE capability inquiry message is communicated from a base station of a radio access network to a UE, wherein the UE capability inquiry message causes the UE to transmit a UE capability information message that comprises one or more carrier aggregation parameters, according to any one or more aspects described with respect to FIGS. 2-3. At a second step 420, the UE capability information message is received by the base station, according to any one or more aspects described with respect to FIGS. 2-3. At a third step 430, a carrier aggregation allocation is communicated to the UE wherein the total number of resource blocks for all of the allocated component carriers is less than or equal to the maximum aggregated resource block value reported by the UE.

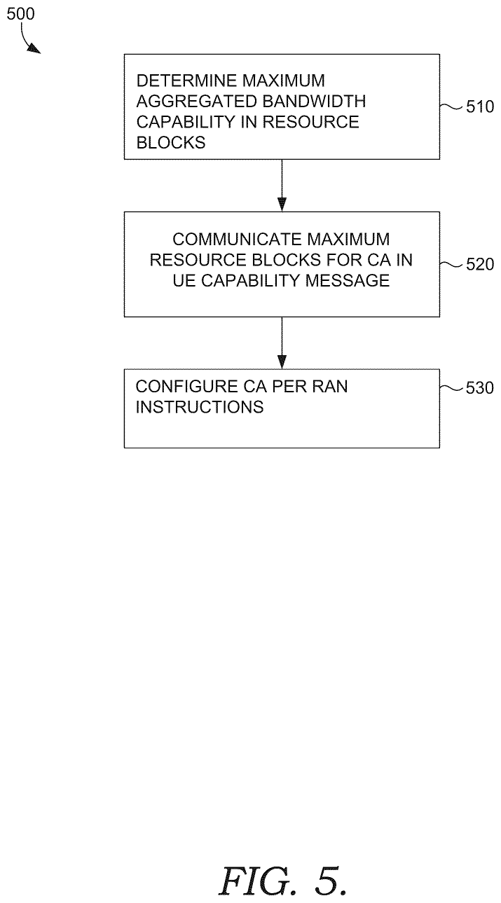

Turning now to FIG. 5, a flow chart representing a method 500 is provided for reporting maximum carrier aggregation bandwidth capacity of a UE. At a first step 510, the method 500 comprises determining a maximum resource block baseband processing capability of the UE. At a second step 520, the method 500 comprises communicating an information element to the base station comprising the maximum resource block baseband processing capability of the UE.

At a third step 530, the method 500 comprises receiving an instruction from the base station to configure a carrier aggregation session, the carrier aggregation comprising a plurality of component carriers, wherein the plurality of component carriers comprises an amount of resource blocks less than the maximum resource block baseband capability of the UE.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A user equipment (UE) for wirelessly communicating with a telecommunication network, comprising:
one or more antennas configured to wirelessly communicate with a base station of a radio access network (RAN); and
one or more computer processing components configured to perform operations comprising:
determining a maximum resource block baseband processing capability of the UE;
communicating an information element to the base station comprising the maximum resource block baseband processing capability of the UE;
receiving an instruction from the base station to configure a carrier aggregation session, the carrier aggregation comprising a plurality of component carriers, wherein the plurality of component carriers comprises an amount of resource blocks less than the maximum resource block baseband capability of the UE.

2. The system of claim 1, wherein the carrier aggregation capability message is communicated to the base station in response to receiving a UE capability inquiry message from the base station.

3. The system of claim 1, wherein the carrier aggregation capability message further comprises a maximum supported aggregated downlink frequency domain duplexed (FDD) bandwidth, a maximum supported aggregated uplink FDD bandwidth, a maximum supported aggregated downlink time domain duplexed (TDD) bandwidth, and a maximum supported aggregated uplink TDD bandwidth.

4. The system of claim 1, wherein the maximum resource block baseband processing capability comprises a single value that represents a total of an uplink capability and a downlink capability.

5. The system of claim 1, wherein the maximum resource block baseband processing capability comprises a first value for the maximum capabilities of a UE's capacity to process downlink bandwidth and a second value for the maximum capabilities of the UE's capacity to process uplink bandwidth.

6. The system of claim 1, wherein the maximum resource block baseband processing capability comprises a total downlink capability and each of a maximum supported aggregated downlink frequency domain duplexed (FDD) bandwidth, and a maximum supported aggregated downlink time domain duplexed (TDD) bandwidth.

7. The system of claim 6, wherein the information element is communicated to the base station without communicating one or more carrier aggregation feature sets, the one or more carrier aggregation feature sets indicating one or more of supported frequency bands, maximum bandwidth, MIMO configurations, subcarrier spacings (SCS), and the number of aggregated component carriers (CCs) the UE can support.

8. A method for wirelessly communicating with a telecommunication network, comprising:
determining a maximum resource block baseband processing capability of the UE;
communicating an information element to the base station comprising the maximum resource block baseband processing capability of the UE;
receiving an instruction from the base station to configure a carrier aggregation session, the carrier aggregation comprising a plurality of component carriers, wherein the plurality of component carriers comprises an amount of resource blocks less than the maximum resource block baseband capability of the UE.

9. The method of claim 8, wherein the carrier aggregation capability message is communicated to the base station in response to receiving a UE capability inquiry message from the base station.

10. The method of claim 9, wherein the information element is communicated to the base station without communicating one or more carrier aggregation feature sets, the one or more carrier aggregation feature sets indicating one or more of supported frequency bands, maximum bandwidth, MIMO configurations, subcarrier spacings (SCS), and the number of aggregated component carriers (CCs) the UE can support.

11. The method of claim 10, wherein the carrier aggregation capability message further comprises a maximum supported aggregated downlink frequency domain duplexed (FDD) bandwidth, a maximum supported aggregated uplink FDD bandwidth, a maximum supported aggregated downlink time domain duplexed (TDD) bandwidth, and a maximum supported aggregated uplink TDD bandwidth.

12. The method of claim 10, wherein the maximum resource block baseband processing capability comprises a single value that represents a total of an uplink capability and a downlink capability.

13. The method of claim 10, wherein the maximum resource block baseband processing capability comprises a first value for the maximum capabilities of a UE's capacity to process downlink bandwidth and a second value for the maximum capabilities of the UE's capacity to process uplink bandwidth.

14. The method of claim 10, wherein the maximum resource block baseband processing capability comprises a total downlink capability and each of a maximum supported aggregated downlink frequency domain duplexed (FDD) bandwidth, and a maximum supported aggregated downlink time domain duplexed (TDD) bandwidth.

15. A method for wirelessly communicating with a telecommunication network, comprising:
determining a maximum resource block baseband processing capability of the UE;
communicating a first information element to the base station comprising an indication that the UE supports an aggregated bandwidth scaling factor;
communicating one or more information elements to the base station comprising the supported aggregated bandwidth of the UE;
receiving an instruction from the base station to configure a carrier aggregation session, the carrier aggregation comprising a plurality of component carriers, wherein the plurality of component carriers is less than the maximum resource block baseband capability of the UE.

16. The method of claim 15, wherein the carrier aggregation capability message is communicated to the base station in response to receiving a UE capability inquiry message from the base station.

17. The method of claim 16, wherein the one or more information elements comprises a total supported aggregated downlink bandwidth.

18. The method of claim 17, wherein the one or more information elements further comprises a maximum supported aggregated downlink frequency domain duplexed (FDD) bandwidth, and a maximum supported aggregated downlink time domain duplexed (TDD) bandwidth.

19. The method of claim 18, wherein the one or more information elements are expressed in MHz.

20. The method of claim 18, wherein the one or more information elements are expressed in an amount of resource blocks.
